(19) United States
(12) Patent Application Publication
(10) Pub. No.: US 2014/0096839 A1
(43) Pub. Date: Apr. 10, 2014

(54) METHOD AND APPARATUS FOR BIAS MEMBER ADJUSTMENT WITHOUT DISASSEMBLY

(71) Applicants: Stanley B. Roedel, Budd Lake, NJ (US); John J. Haller, Boonton, NJ (US); Gerard A. Carty, Kearny, NJ (US)

(72) Inventors: Stanley B. Roedel, Budd Lake, NJ (US); John J. Haller, Boonton, NJ (US); Gerard A. Carty, Kearny, NJ (US)

(73) Assignee: AUTOMATIC SWITCH COMPANY, Florham Park, NJ (US)

(21) Appl. No.: 13/647,086

(22) Filed: Oct. 8, 2012

(51) Int. Cl. F16K 51/00

(52) U.S. Cl. 137/15.18

(57) ABSTRACT

A process control valve with a spring rate adjustment and a spring force adjustment, thereby accommodating tight spring tolerances, such as those encountered in low power and proportional applications. The spring rate and spring force may both be adjusted after the valve has been fully assembled, thereby reducing manufacturing costs.

CROSS REFERENCE TO RELATED APPLICATIONS

None.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to process control valves; and more specifically relate to control valves that require tight tolerance springs, such as low power and/or proportional valves.

2. Description of the Related Art

U.S. Pat. No. 4,524,947 discloses a “normally closed spool type solenoid-controlled valve which changes its opening in proportion to the amount of current supplied to the solenoid. The spool which blocks the valve opening in an overlapping relation is held in a closed position by a dual spring design having differing spring rates wherein the lighter spring holds the spool in an overlapping closed position.”

U.S. Pat. No. 4,863,142 discloses a “solenoid valve which includes a valve body having a central bore from which fluid passages radially extend. A valve spool is axially slidably captured within the valve body bore to control passage of fluid among the valve body passages. An electromagnetic variable force motor is mounted on the valve body and includes a housing of ferromagnetic construction with a pole piece of ferromagnetic construction coaxial with the valve spool and surrounded by an electrical coil. An armature comprising a ball of ferromagnetic construction is positioned coaxially with the pole piece in abutting engagement with the valve spool. A coil spring is positioned to engage the ball-armature and to urge the same axially away from the pole piece. The characteristic of magnetic attraction between the ball-armature and the opposing face of the pole piece as a function of separation therebetween is substantially identical with spring rate, both preferably being a linear function of ball-armature displacement.”

U.S. Pat. No. 5,000,420 discloses a “solenoid valve which includes a valve body having a central bore from which fluid passages radially extend. A valve spool is axially slidably captured within the valve body bore to control passage of fluid among the valve body passages. An electromagnetic variable force motor is mounted on the valve body and includes a housing of ferromagnetic construction with a pole piece of ferromagnetic construction coaxial with the valve spool and surrounded by an electrical coil. An armature comprising a ball of ferromagnetic construction is positioned coaxially with the pole piece in abutting engagement with the valve spool. A coil spring is positioned to engage the ball-armature and to urge the same axially away from the pole piece. The characteristic of magnetic attraction between the ball-armature and the opposing face of the pole piece as a function of separation therebetween is substantially identical with spring rate, both preferably being a linear function of ball-armature displacement.”

U.S. Pat. No. 5,051,631 discloses an “electromagnetic variable force motor circuit comprising a solenoid including a coil, a pole piece associated with the coil and a ball armature. A spring urges the ball armature toward a first seat and away from the pole piece. A first chamber is provided adjacent the first seat, the ball armature and the first seat define a first orifice extending between the ball armature and the first chamber. A first passage provides supply pressure to the first chamber. A second orifice is provided in the first passage. A valve including a movable member responsive to fluid pressure is provided in the first chamber. A second passage provides supply pressure to the valve. A third passage provides control flow from the valve device. A fourth passage provides exhaust flow from the first chamber when the ball armature is moved away from the first seat such that the ball armature controls flow through the first orifice to the fourth passage upon excitation of the coil. The valve is operable to variably restrict flow in the second and third passages.”

U.S. Pat. No. 5,060,695 discloses a “pressure regulating device regulates the pressure of a flowing medium and includes a stationary member. A movable armature is disposed axially from the stationary member for moving axially in relation to the stationary member. A coil is disposed about the stationary member and the armature and through which current flows for generating magnetic flux to create an attractive force to move the armature in relation to the stationary member. A housing is disposed about the coil and the stationary member and the armature for encasing the armature and the coil and the stationary member. At least one aperture is formed in the housing to allow a fluid medium to enter and exit the housing and to contact the armature. A means bleeds a portion of the fluid medium based on the current to the coil to control the output pressure to predetermined levels.”

U.S. Pat. No. 5,240,227 discloses an “electromagnetically operated valve communicating with a pressurized fluid in an oil-filled chamber, [that] includes an armature (17) resiliently retained in an armature chamber (16) of a housing (10) by membrane springs (22,23); an armature-operated valve body (20) movable with clearance in a hole (34) provided in the housing (10) and a compression spring (40) biasing the armature. The armature chamber (16) is hermetically sealed in the housing from a valve part (15) against which the valve body (20) is urged by the compression spring and contains a damping fluid for damping motions of the armature. The housing is also provided with a first compensating chamber (44) communicating with the armature chamber (16) to compensate for a volume change of the damping fluid and with a second compensating chamber (46) connected with the first compensating chamber via a duct (45). The second compensating chamber is filled with air and communicates with the oil-filled chamber filled with the pressurized fluid so that dirt and other particles in the pressurized fluid cannot reach the damping fluid of the armature chamber.”

U.S. Pat. No. 5,611,370 discloses a “proportional variable force solenoid valve for controlling the pressure of a pressurized fluid in a fluid control system in proportion to the current level of an electrical input signal comprises a movable valve for controlling the pressure of pressurized fluid in the fluid control system and a solenoid for controlling movement of the valve in linear proportion to the current level of the electrical signal. The movable valve and the solenoid are disposed in a common substantially non-magnetic housing to provide a fluid control unit. The housing may comprise an aluminum casting for insertion in an aluminum transmission body. A movable armature of the solenoid may comprise a cylindrical shaped permanent magnet, rather than a ferromagnetic armature, in order to eliminate the need for a axially magnetized permanent magnet ring. A simplified armature suspension structure, fluid diverting valve mechanism, and electromagnetic flux washer are incorporated.”

U.S. Pat. No. 5,799,688 discloses a “pressure valve having a fluid inlet, a first chamber, a throughbore, a second chamber, a fluid outlet and a valve stem. The valve stem is mounted within a valve body and has several different diameters. A pressure condition within one or more of the chambers acts upon the valve stem to urge the stem into either an open position or a closed position, depending upon the design of the valve. The valve is particularly suitable for bypass valves, pressure regulating valves, over-pressure protection valves, lost-pressure protection valves, and other pressure-sensitive valve applications.”

International Patent Application Publication No. WO2011087973 discloses a “solenoid valve is provided which includes a valve member, an armature for moving the valve member, an electro-magnetic coil for inducing movement of the armature. A coil spring is provided for engagement with the armature, the coil spring has at least a first end being generally cylindrical and a second end contacting the armature. A plug is provided threadably engaged with the spring first end along an adjustable length of the spring.”

The inventions disclosed and taught herein are directed to an improved process control valve that accommodates tight tolerance springs, and is thus particularly well suited to low power applications and/or proportional valves.

### BRIEF SUMMARY OF THE INVENTION

A process control valve with a spring rate adjustment and a spring force adjustment, thereby accommodating tight spring tolerances, such as those encountered in low power and proportional applications. The spring rate and spring force may both be adjusted after the valve has been fully assembled, thereby reducing manufacturing costs.

For example, a valve of the present invention may be assembled with a plunger adjacent a valve seat, an operating spring adjacent the plunger, a rate adjuster, and a force adjuster. The spring may bias the plunger toward the valve seat. The rate adjuster may thread within, or upon, the spring, such that the rate adjuster selectively controls how many coils of the spring are active, thereby controlling the spring rate. The force adjuster preferably controls a spring force exerted by the spring upon the plunger. For example, the force adjuster may pre-compress, or pre-tension, the spring, such as by moving the rate adjuster toward, or away from, the plunger and/or valve seat.

In any case, the valve may be calibrated, with the valve assembled and without disassembling the valve. For example, the spring rate may be adjusted by moving the rate adjuster with respect to the spring and/or while holding the force adjuster fixed. The spring force may be adjusted by moving the force adjuster relative to the plunger and/or while holding the rate adjuster fixed.

### BRIEF DESCRIPTION OF THE SEVERAL VIEWS OF THE DRAWINGS

FIG. 1 illustrates cross-sectional view of a particular embodiment of a process control valve utilizing certain aspects of the present inventions; and

FIG. 2 illustrates a top plan view of the valve of FIG. 1.

### DETAILED DESCRIPTION OF THE INVENTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

A process control valve's spring rate and/or force may be particularly important in low power and/or proportional valve applications. This importance may require springs with relatively tight tolerances. These tolerances may be met by use of more expensive to manufacture springs, labor intensive spring testing and selection, and/or some means by which the spring rate and/or force can be adjusted. Prior approaches utilizing the last two options often require labor intensive iterative process by which a valve is assembled, tested, and them must be disassembled to make adjustments/replacements.

Applicants have created a process control valve with a spring rate adjustment and a spring force adjustment, thereby accommodating tight spring tolerances, where the spring rate and spring force may both be adjusted after the valve has been fully assembled, thereby reducing manufacturing costs.

For example, a valve of the present invention may be assembled with a plunger adjacent a valve seat, an operating spring adjacent the plunger, a rate adjuster, and a force adjuster. The spring may bias the plunger toward the valve seat. The rate adjuster may thread within, or upon, the spring, such that the rate adjuster selectively controls how many coils of the spring are active, thereby controlling the spring rate. The force adjuster preferably controls a spring force exerted by the spring upon the plunger. For example, the force adjuster may pre-compress, or pre-tension, the spring, such as by moving the rate adjuster toward, or away from, the plunger and/or valve seat.

In any case, the valve may be calibrated, with the valve assembled and without disassembling the valve. For example, the spring rate may be adjusted by moving the rate adjuster with respect to the spring and/or while holding the force adjuster fixed. The spring force may be adjusted by moving the force adjuster relative to the plunger and/or while holding the rate adjuster fixed.

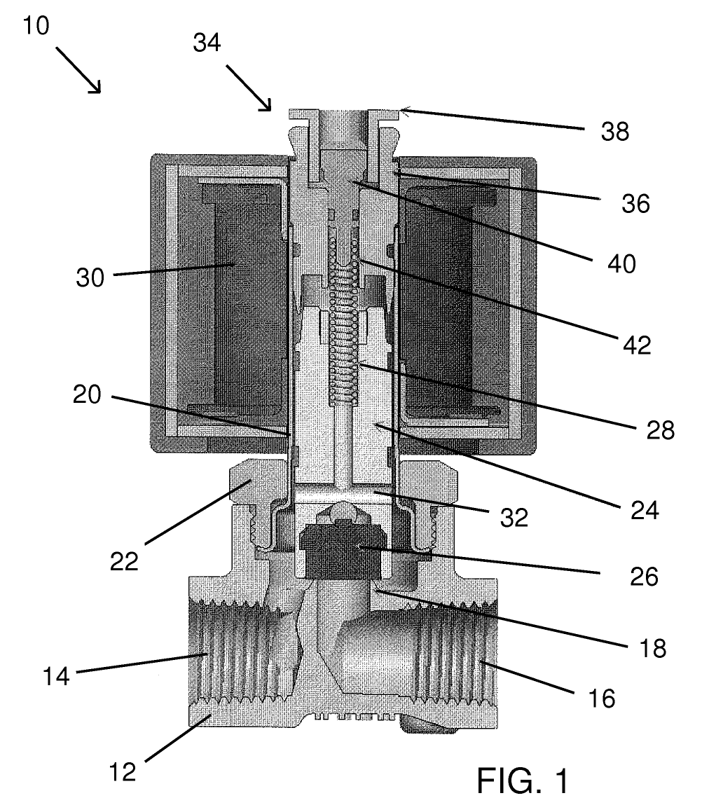

FIG. 1 is an illustration of a process control valve 10 utilizing certain aspects of the present inventions. The valve 10 includes a valve body 12, having an inlet 14, an outlet 16, and a valve seat 18 there between. The valve 10 may also include a sleeve 20 and a cap 22 that secures and seals the sleeve to the body 12. In other embodiments, the sleeve 20 and/or cap 22 may be integral with the body 12. In any case, the sleeve 20 and/or cap 22 may be referred to as part of the body 12.

A plunger 24 may be slidably received within the sleeve 20 and selectively abut the seat 18 in order to close the valve 10, thereby selectively allowing or blocking communication between the inlet 14 and outlet 16. The plunger 24 may include a seal 26 to more effectively mate with the seat 18 in order to close the valve 10.

The plunger 24 may be biased toward the seat 18 by a spring 28. The plunger 24 may be normally operated by a solenoid coil 30. The plunger 24 may also include a channel 32 to equalize pressure on either end of the plunger 24.

A distal end of the spring 28 may be secured by an adjustment assembly 34. The adjustment assembly 34 may comprise a plug 36 that is secured within the sleeve 20 and/or solenoid coil 30. The plug 36 may be threaded or press fit within the sleeve 20 and/or solenoid coil 30. In any case, the plug preferable seals a distal end of the sleeve 20, and thus the valve body 12. While the plug 34 may be removable, removal of the plug 34 is not necessary or even preferred for calibration, or adjustment, of the spring rate adjustment and/or spring force of the valve 10.

The spring force may be controlled by a force adjuster 38. The force adjuster 38 may pre-compress the spring 28 in order to control the spring force. For example, the force adjuster 38 may compress the spring 28 by moving toward the plunger 24 and/or valve seat 18, thereby requiring the solenoid coil 30 to generate a stronger magnetic field in order to overcome the spring 28 and open the valve 10. Conversely, if the if the solenoid coil 30 is unable to generate a strong enough magnetic field to overcome the spring 28 and open the valve 10, the force adjuster 38 may be moved away from the plunger 24 and/or valve seat 18. In other embodiments, rather than compress the spring 28, the force adjuster 38 may tension the spring 28.

As shown, the force adjuster 38 may be threaded into the plug 36, such that rotating the force adjuster 38 moves the force adjuster 38 toward the plunger 24 and/or valve seat 18, thereby compressing the spring 28, or away from the plunger 24 and/or valve seat 18, thereby relaxing the spring 28. As can be seen, the force adjuster 38 is fully functional, and can be adjusted, with the valve 10 fully assembled.

The spring rate may be controlled by a rate adjuster 40. The rate adjuster 40 may thread within, or onto, the spring 28 in order to control the spring rate. For example, the rate adjuster 40 may be thread into the spring 28, thereby decreasing a number of active coils of the spring 28 and increasing the spring rate. Conversely, the rate adjuster 40 may be thread out of the spring 28, thereby increasing the number of active coils of the spring 28 and decreasing the spring rate.

As shown, the rate adjuster 40 may be threaded into the force adjuster 38, such that rotating the rate adjuster 40 lengthens an engagement 42 of the rate adjuster 40 and the spring 28, thereby decreasing a number of active coils of the spring 28, or shortens the engagement 42 of the rate adjuster 40 and the spring 28, thereby increasing a number of active coils of the spring 28. As can be seen, the rate adjuster 40 is fully functional, and can be adjusted, with the valve 10 fully assembled.

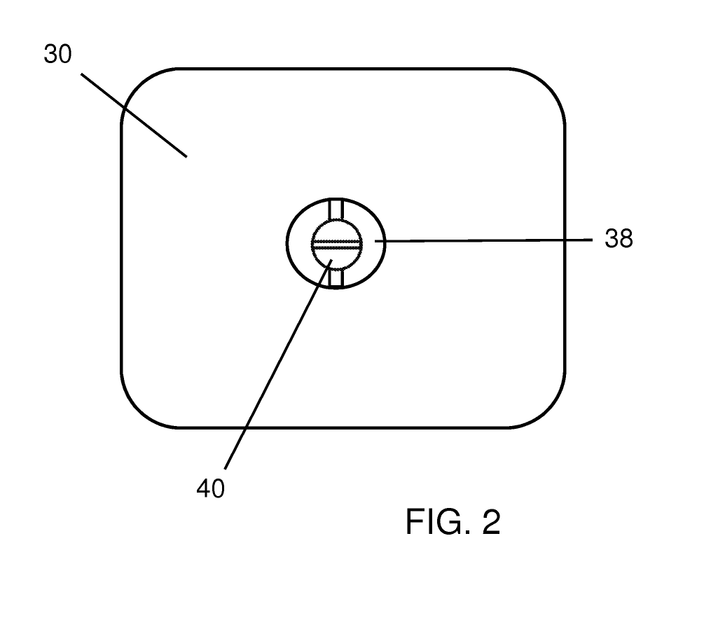

FIG. 2 shows how the force adjuster 38 and/or rate adjuster 40 may be rotated using conventional screw drivers. More specifically, one screw driver may be used to rotate, or hold, the rate adjuster 40 while another is used to rotate the force adjuster 38. Alternatively, one screw driver may be used to rotate, or hold, the force adjuster 38 while another is used to rotate the rate adjuster 40.

In an alternative embodiment, the plug 36 may act as the spring force adjuster, thereby negating the need for a separate force adjuster 38. In this case, the plug 36 may be threaded into the sleeve 20, such that rotating the plug 36 moves the plug 36 toward the plunger 24 and/or valve seat 18, thereby compressing the spring 28, or away from the plunger 24 and/or valve seat 18, thereby relaxing the spring 28. As can be seen, the force adjusting plug of this embodiment is fully functional, such that the spring force can be adjusted, with the valve 10 fully assembled.

In this alternative embodiment, the rate adjuster 40 may be threaded into the plug 36, such that rotating the rate adjuster 40 moves the rate adjuster 40 within the spring 28, thereby decreasing a number of active coils of the spring 28, or out of the spring 28, thereby increasing a number of active coils of the spring 28. As can be seen, the rate adjuster 40 remains fully functional, and can be adjusted, with the valve 10 fully assembled.

In either embodiment, it is envisioned that spring rate is adjusted by rotating the rate adjuster 40 relative to the force adjuster 38, or force adjusting plug 36, while the force adjuster is held fixed relative to the sleeve 20. It is also envisioned that the spring force is adjusted by rotating the force adjuster 38, or force adjusting plug 36, while the rate adjuster 40 is held fixed relative to the sleeve 20 and/or spring 28.

Other and further embodiments utilizing one or more aspects of the inventions described above can be devised without departing from the spirit of Applicant's invention. For example, the spring 28 may thread into, or onto, the plunger 24 in order to control the spring rate. In this case, the rate adjuster 40 may merely rotate the spring 28 with respect to the plunger 24 in order to control the spring rate. Additionally, the present inventions may be used with a spool valve and may therefore not need the seat 18 described above. Further, the various methods and embodiments of the present invention can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A method of assembling and calibrating a process control valve, comprising the steps of:
assembling the valve, by—
placing a plunger within a valve body;
placing an operating spring adjacent the plunger;
placing a rate adjuster adjacent the spring; and
placing a force adjuster adjacent the rate adjuster; and
calibrating the valve, with the valve assembled.

2. The method of claim 1, wherein calibrating the valve, with the valve assembled, comprises adjusting a spring rate by moving the rate adjuster while holding the force adjuster fixed relative to the valve body.

3. The method of claim 1, wherein calibrating the valve, with the valve assembled, comprises adjusting a spring force by moving the force adjuster while holding the rate adjuster fixed relative to the valve body.

4. The method of claim 1, wherein the valve is assembled by threading the force adjuster into the valve.

5. The method of claim 1, wherein the valve is assembled by threading the rate adjuster in the force adjuster.

6. The method of claim 1, wherein the valve is assembled by threading the rate adjuster into the spring.

7. The method of claim 1, wherein the step of calibrating the valve is performed with the valve assembled, such that the plunger is within the valve body, the operating spring is adjacent the plunger, the rate adjuster is adjacent the spring, and the force adjuster adjacent the rate adjuster.

8. The method of claim 1, wherein the step of calibrating the valve is performed after the valve is assembled and without disassembling the valve.

9. The method of claim 1, wherein the step of calibrating the valve includes adjusting a spring rate of the valve after the valve is assembled and without disassembling the valve.

10. The method of claim 1, wherein the step of calibrating the valve includes adjusting a spring force of the valve after the valve is assembled and without disassembling the valve.

11. A method of assembling and calibrating a process control valve, comprising the steps of:
assembling the valve, by—
assembling a plunger with a valve body;
assembling an operating spring with the plunger, such that the spring biases the plunger;
assembling a rate adjuster with the spring, such that the rate adjuster selectively controls how many coils of the spring are active; and
assembling a force adjuster with the valve, such that the force adjuster controls a spring force exerted by the spring upon the plunger; and
calibrating the valve, with the valve assembled.

12. The method of claim 11, wherein calibrating the valve, with the valve assembled, comprises adjusting a spring rate by moving the rate adjuster while holding the force adjuster fixed relative to the valve body.

13. The method of claim 11, wherein calibrating the valve, with the valve assembled, comprises adjusting the spring force by moving the force adjuster while holding the rate adjuster fixed relative to the valve body.

14. The method of claim 11, wherein the valve is assembled by threading the force adjuster into the valve.

15. The method of claim 11, wherein the valve is assembled by threading the rate adjuster in the force adjuster.

16. The method of claim 11, wherein the valve is assembled by threading the rate adjuster into the spring.

17. The method of claim 11, wherein the valve is calibrated with the valve assembled, such that the plunger is within the valve body, the operating spring is adjacent the plunger, the rate adjuster is adjacent the spring, and the force adjuster adjacent the rate adjuster.

18. The method of claim 11, wherein the step of calibrating the valve includes adjusting a spring rate of the valve after the valve is assembled and without disassembling the valve.

19. The method of claim 11, wherein the step of calibrating the valve includes adjusting a spring force of the valve after the valve is assembled and without disassembling the valve.

20. A method of assembling and calibrating a process control valve, comprising the steps of:
assembling the valve, by—
placing a plunger adjacent a valve seat within a valve body;
placing an operating spring adjacent the plunger, such that the spring biases the plunger toward the valve seat;
threading a rate adjuster with respect to the spring such that the rate adjuster selectively controls how many coils of the spring are active; and
threading a force adjuster with respect to the rate adjuster such that the force adjuster controls a spring force exerted by the spring upon the plunger; and
calibrating the valve, with the valve assembled and without disassembling the valve such that the plunger is adjacent the valve seat, the operating spring is adjacent the plunger, the rate adjuster is adjacent the spring, and the force adjuster adjacent the rate adjuster, by
adjusting a spring rate by moving the rate adjuster while holding the force adjuster fixed relative to the valve body; and
adjusting the spring force by moving the force adjuster while holding the rate adjuster fixed relative to the valve body.
